(19) United States
(12) Patent Application Publication
(10) Pub. No.: US 2008/0232734 A1
(43) Pub. Date: Sep. 25, 2008

(54) BEARING STRAP ASSEMBLY

(76) Inventors: Paul A. Elio, Phoenix, AZ (US); Hari Sankara Iyer, Scottsdale, AZ (US); Robert E. Glaspie, Scottsdale, AZ (US); Glen A. Mussi, Chandler, AZ (US)

Correspondence Address: ROBERT A. PARSONS, 4000 N. CENTRAL AVENUE, SUITE 1220, PHOENIX, AZ, 85012, US

(21) Appl. No.: 12/052,600

(22) Filed: Mar. 20, 2008

Related U.S. Application Data
(60) Provisional application No. 60/895,802, filed on Mar. 20, 2007.

(51) Int. Cl. F16C 33/00

(52) U.S. Cl. 384/627

(57) ABSTRACT

A bearing strap assembly includes an elongated strap of flexible material and a plurality of insert bearing buttons affixed to one side of the strap. The inserts extend transversely from the one side of the strap and are spaced apart along the length of the strap. In one use, an inner and an outer circular cylinder are concentrically positioned for relative movement therebetween. The outer cylinder has a plurality of holes extending transversely therethrough from an outside surface to an inside surface and the holes are spaced apart coextensive with the bearing buttons. The elongated strap is engaged about the outside surface of the outer cylinder with the bearing buttons extending through the holes and into engagement with an outer surface of the inner cylinder.

### CROSS REFERENCE TO RELATED APPLICATION

This application claims the benefit of U.S. Provisional Patent Application No. 60/895,802, filed 20 Mar. 2007.

### FIELD OF THE INVENTION

This invention generally relates to bearings for use between relative movable surfaces.

### BACKGROUND OF THE INVENTION

Bearings are well known in the mechanical industries and are used between relative moving or movable surfaces, such as wheel and axle, to allow smooth relative movement. A myriad of different types of bearings have been devised over the years, including ball bearings, roller bearings, smooth bearing surfaces, etc. In all instances, the major problem that arises is that the relative movable surfaces must be extremely accurate, i.e., they must be constructed with very close tolerances. Taking the wheel and axle as an example and assuming the wheel is mounted on the axle using a ball bearing, the outer race of the ball bearing is frictionally engaged in a central opening of the wheel and the inner race is frictionally engaged over the outer surface of the axle. Thus, the diameter of the central opening must be constructed with a very low or close tolerance to frictionally receive the outer race. Also, the outer surface of the axle must be constructed with a very low or close tolerance to frictionally receive the inner race of the ball bearing. Similarly, any bearings or bearing surfaces and the associated structure must be constructed with a very close tolerance to ensure the proper operation of the bearing or bearing surface. It is well known in the art that this necessary close tolerance adds substantially to the cost of the product.

It would be highly advantageous, therefore, to remedy the foregoing and other deficiencies inherent in the prior art.

Accordingly, it is an object of the present invention to provide a new and improved bearing structure or apparatus that does not require a close tolerance between relative movable surfaces.

It is another object of the present invention to provide a new and improved bearing structure or apparatus that is adjustable within limits to compensate for differences between relative movable surfaces.

### SUMMARY OF THE INVENTION

Briefly, to achieve the desired objects and advantages of the present invention in accordance with a preferred embodiment, a bearing strap assembly includes an elongated strap of flexible material and a plurality of insert bearing buttons affixed to one side of the strap so as to extend transversely from the one side.

In one specific embodiment, bearing strap assembly includes an elongated strap of flexible material and a plurality of insert bearing buttons affixed to one side of the strap. The inserts extend transversely from the one side of the strap and are spaced apart along the length of the strap. In one use, an inner and an outer circular cylinder are concentrically positioned for relative movement therebetween. The outer cylinder has a plurality of holes extending transversely therethrough from an outside surface to an inside surface and the holes are spaced apart coextensive with the bearing buttons. The elongated strap is engaged about the outside surface of the outer cylinder with the bearing buttons extending through the holes and into engagement with an outer surface of the inner cylinder.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is top view of a bearing strap assembly in accordance with the present invention;

FIG. 2 is a side view of the bearing strap assembly of FIG. 1;

FIG. 3 is a bottom view of the bearing strap assembly of FIG. 1;

FIGS. 4-7 are side, front, top, and perspective views, respectively, of the bearing strap assembly of FIG. 1 in an assembled position;

FIG. 8 is a side view of the bearing strap of FIG. 1 in a partially assembled position on a structure including two relative movable surfaces;

FIG. 9 is a side view similar to FIG. 8 illustrating the bearing strap fully assembled in position;

FIG. 10 is a plan view of a portion of the structure of FIG. 8;

FIG. 11 is a perspective view of the assembled bearing strap and structure of FIG. 9; and

FIGS. 12-15 illustrate the bearing load calculations for a specific example of a bearing strap assembly similar to the FIG. 1 embodiment.

### DETAILED DESCRIPTION OF A PREFERRED EMBODIMENT

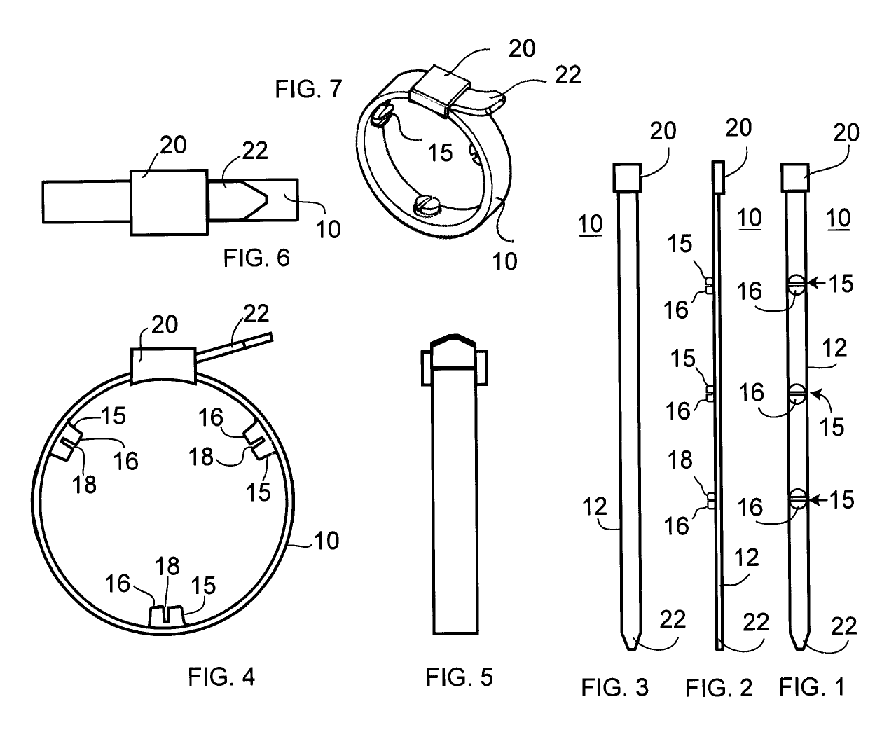

Turning now to the drawings, attention is first directed to FIGS. 1-3 which illustrate three different views of bearing apparatus, in this specific embodiment a bearing strap assembly 10, in accordance with the present invention. In this specific embodiment, bearing strap assembly 10 includes an elongated strap 12 of flexible material with a plurality of insert bearing buttons (hereinafter referred to simply as “inserts”) 15 affixed to one side thereof so as to extend transversely from the one side. It will be understood from the following discussion that strap 12 and inserts 15 can be formed of the same material (for example, formed as an integral unit) or they can be formed separately and assembled by any convenient method. In some applications where stretching stress (described in more detail below) is a potential problem, strap 12 could be made of material such as flexible steel or other suitable metal with inserts 15 mounted thereon.

In either instance, inserts 15 are formed of some material that provides a bearing surface 16 for the relative movement of some surface thereacross. Suitable materials for inserts 15 include any bearing grade polymer, such as Teflon, nylon, etc. Also, in this specific embodiment inserts 15 are formed with a notch or a slot 18 that is reduced slightly in width as it increases in depth (i.e., generally V-shaped). As will be understood from the following description of the use of strap 10, slot 18 allows some radial compression of insert 15 during assembly and use. Also, slot 18 reduces the bearing surface to better dissipate any heat that may be generated.

Bearing strap 10 also carries a buckle 20 adjacent one end that is designed to receive an opposite end 22 of strap 10 therethrough and hold it firmly in place. Generally, buckle 20 includes a type of ratcheting structure, well known in the art, that firmly grips opposite end 22 of strap 10 once it is inserted and prevents the removal thereof. Referring additionally to FIGS. 4-7, the assembled position of strap 10 can be seen with opposite end 22 inserted through buckle 20 and held firmly in place. In this position, inserts 15 are directed inwardly.

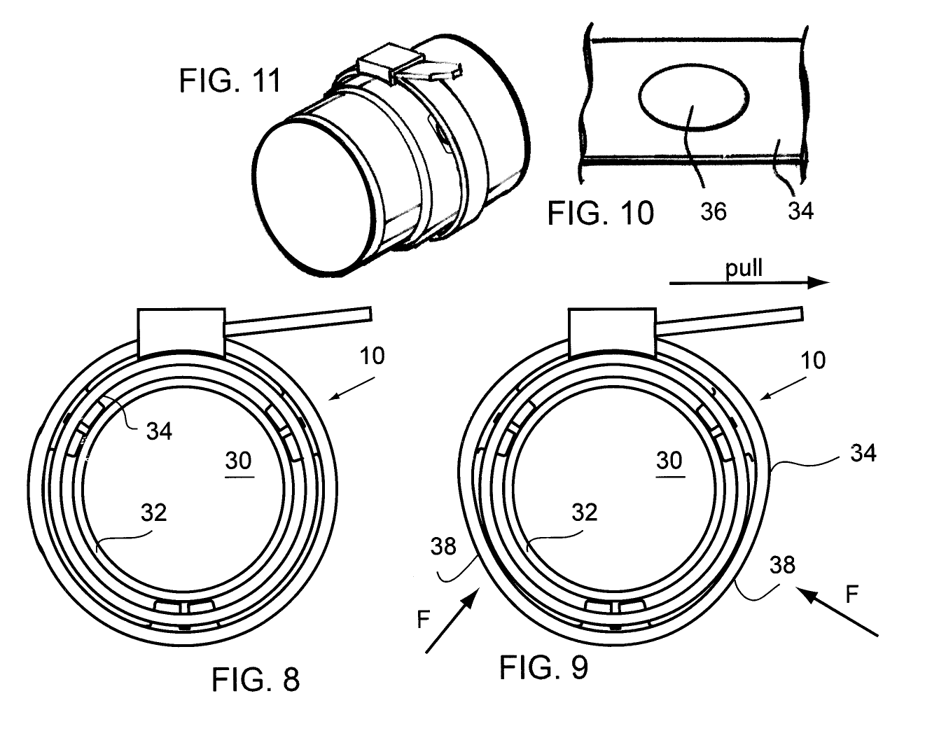

Turning now to FIGS. 8-11, the relative movable surfaces requiring bearings to enhance relative movement include (for purposes of this explanation) concentric right circular cylinders 30 (having a circular cross-section) designed for relative rotary or longitudinal movement. Concentric cylinders 30 include an inner cylinder 32 and an outer cylinder 34. For the purpose of installing bearing strap 10, outer cylinder 34 has a plurality of spaced apart holes 36 formed therethrough. Each hole 36 through outer cylinder 34 is positioned to receive an insert 15 therethrough so that bearing surface 16 bears against and supports inner cylinder 32.

As can be seen from a comparison of FIGS. 8 and 9, with inserts 15 positioned in holes 36 strap 12 is pulled sufficiently to tighten strap 12 against portions (designated 38 in FIG. 9) of the outer surface of outer cylinder 34 between inserts 15. During this installation or assembling process, there will be a slight relative circumferential movement between strap 12 and outer cylinder 34. Much or most of this movement can be compensated by relatively accurate positioning of holes 36. To reduce the required accuracy (i.e., slacken the tolerance) slots 18 are optionally provided in inserts 15 to allow a slight amount of pinching together during assembly or installation, if desired or convenient.

Also or alternatively, in some specific applications, holes 36 can be formed with a very small oval shape (see FIG. 10) to more easily allow assembly while not allowing relative circumferential movement between strap 12 and outer cylinder 34 during use (i.e., after assembly). In this fashion the smaller diameter ends of inserts 15 can be positioned in holes 36 without necessarily being centered. As strap 12 is tightened inserts 15 move toward the center of holes 36 and extend further therethrough because the diameter of hole 36 is slightly larger (because of the oval shape) and can receive insert 15 fully therein.

Inserts 15 extend through holes 36 in outer cylinder 34 to bear against and support inner cylinder 32 on bearing surfaces 16. Assuming for purposes of explanation that some weight is carried by inner cylinder 32, that weight will bear against the lower insert 25 in FIG. 9, producing a stretching stress on strap 12 that will in turn cause strap 12 to push radially inwardly against outer cylinder 34 at portions 38. As a first consideration, strap 12 is designed so that any anticipated stretching stress does not cause it to stretch sufficiently to allow the lower insert 15 to move out of hole 36 in outer cylinder 34. As a second consideration, outer cylinder 34 must be sufficiently strong to withstand any radial force F at portions 38 while substantially maintaining concentricity between outer cylinder 34 and inner cylinder 32. It will be noted that sufficient loss of concentricity could result in cylinders 32 and 34 engaging and possibly resulting in loss of relative movement.

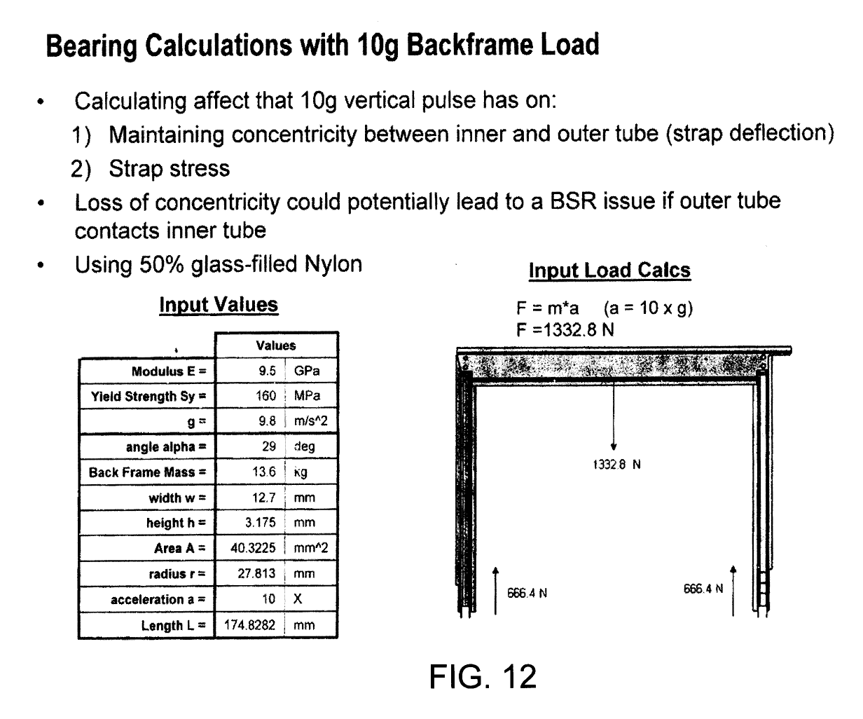

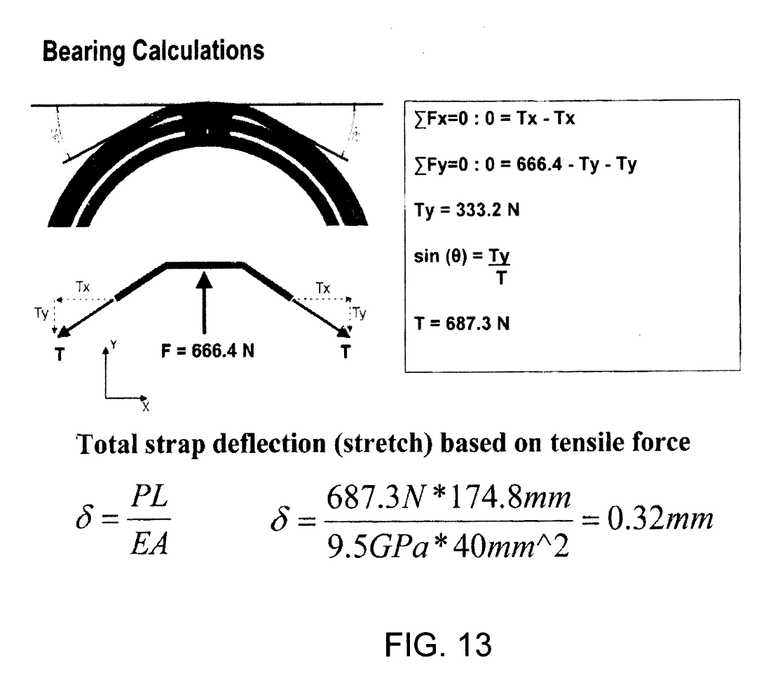

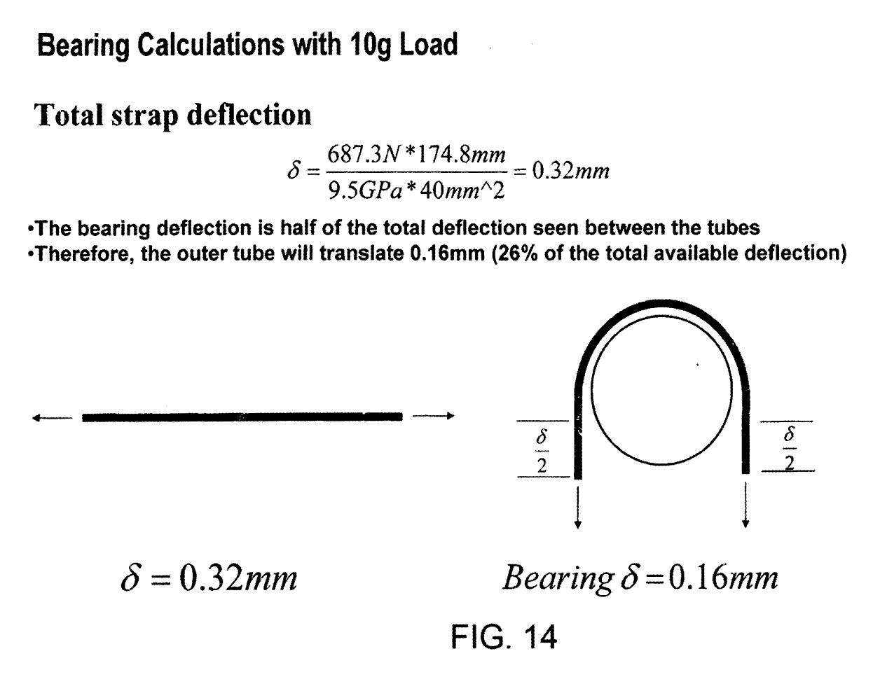

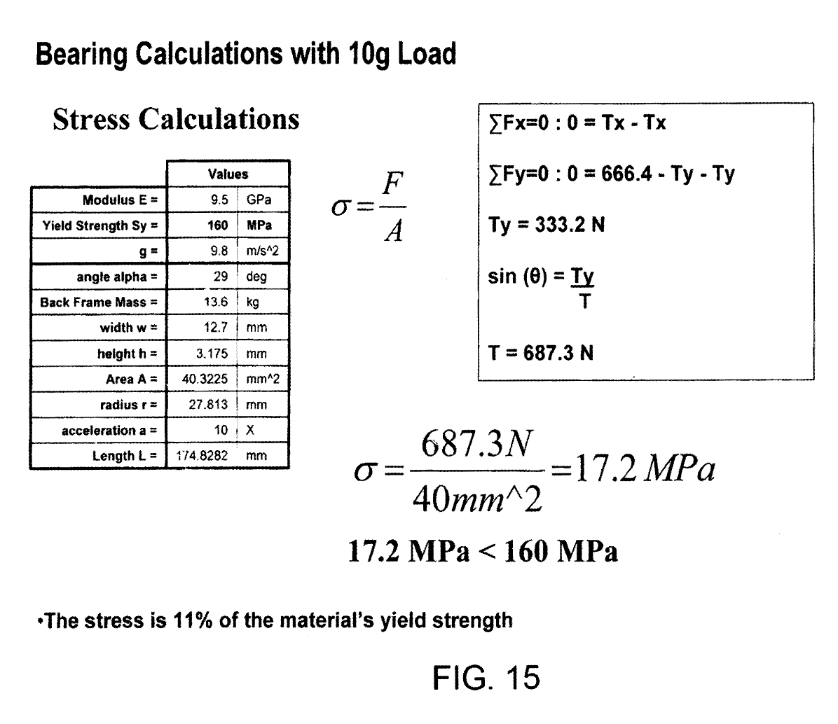

Turning to FIGS. 12-15, bearing load calculations for a specific example of a bearing strap assembly in accordance with the present invention are illustrated. In this specific example, a 10 g (ten times normal gravity) vertical pulse was applied to the inner tube of a bearing strap assembly 10 on concentric right circular cylinders 30 designed for relative rotary or longitudinal movement (as explained in conjunction with FIGS. 8-11 above). No catastrophic loss of concentricity occurred or overstressing of strap 12.

Thus, bearing strap 10 automatically adjusts for all tolerance variations for both inner cylinder 32 and outer cylinder 34 and concentric cylinders 30 can be manufactured with substantially eased tolerances. It should be noted that concentric right circular cylinders have been used to simplify this explanation but the bearing apparatus of the present invention could be used in any of a large variety of structures with relative moving parts. For example, the structure could include other than right circular cylinders, such as cylinders with square cross-sections wherein the relative movement is longitudinal rather than rotary.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A bearing strap assembly comprising:
an elongated strap of flexible material; and
a plurality of insert bearing buttons affixed to one side of the strap so as to extend transversely from the one side.

2. A bearing strap assembly as claimed in claim 1 wherein the elongated strap is formed of flexible steel.

3. A bearing strap assembly as claimed in claim 1 wherein the insert bearing buttons are formed of a bearing grade polymer.

4. A bearing strap assembly as claimed in claim 3 wherein the insert bearing buttons include one of Teflon and nylon.

5. A bearing strap assembly as claimed in claim 1 further including a buckle adjacent one end designed to receive an opposite end of the strap therethrough so as to hold the strap firmly in place.

6. A bearing strap assembly as claimed in claim 5 wherein the buckle includes a type of ratcheting structure.

7. A bearing strap assembly as claimed in claim 1 wherein each of the insert bearing buttons includes a face directed away from the one side of the strap and each face has a notch formed therein.

8. A bearing strap assembly comprising:
an elongated strap of flexible material;
a buckle affixed to the strap adjacent one end of the strap, the buckle designed to receive an opposite end of the strap therethrough so as to hold the strap firmly in place;
a plurality of insert bearing buttons affixed to one side of the strap so as to extend transversely from the one side, the bearing buttons being spaced apart along the length of the strap; and
each of the insert bearing buttons including a face directed away from the one side of the strap and each face having a notch formed therein.

9. A bearing strap assembly as claimed in claim 8 wherein the buckle includes a type of ratcheting structure.

10. A bearing strap assembly as claimed in claim 8 wherein the elongated strap is formed of flexible steel.

11. A bearing strap assembly as claimed in claim 8 wherein the insert bearing buttons are formed of a bearing grade polymer.

12. A bearing strap assembly as claimed in claim 11 wherein the insert bearing buttons include one of Teflon and nylon.

13. A bearing strap assembly comprising:
an elongated strap of flexible material;
a plurality of insert bearing buttons affixed to one side of the strap so as to extend transversely from the one side, the bearing buttons being spaced apart along the length of the strap;
an inner circular cylinder and an outer circular cylinder concentrically positioned for relative movement therebetween, the outer cylinder having a plurality of holes extending transversely therethrough from an outside surface to an inside surface, the holes being spaced apart coextensive with the bearing buttons; and
the elongated strap being engaged about the outside surface of the outer circular cylinder with the bearing buttons extending through the holes and into engagement with an outer surface of the inner circular cylinder.

14. A bearing strap assembly as claimed in claim 13 further including a buckle affixed to the strap adjacent one end of the strap, the buckle designed to receive an opposite end of the strap therethrough so as to hold the strap firmly in place about the outer circular cylinder.

15. A bearing strap assembly as claimed in claim 13 wherein the inner circular cylinder and the outer circular cylinder are mounted for one of relative rotary and relative longitudinal movement.

16. A bearing strap assembly as claimed in claim 13 wherein the elongated strap is formed of flexible steel.

17. A bearing strap assembly as claimed in claim 13 wherein the insert bearing buttons are formed of a bearing grade polymer.

18. A bearing strap assembly as claimed in claim 13 wherein the insert bearing buttons include one of Teflon and nylon.

19. A bearing strap assembly as claimed in claim 13 wherein each of the insert bearing buttons includes a face directed away from the one side of the strap and each face has a notch formed therein.

20. A bearing strap assembly as claimed in claim 19 wherein each of the notches is formed to allow some radial compression of the bearing button during assembly.
